(19) United States
(12) Patent Application Publication
(10) Pub. No.: US 2013/0203006 A1
(43) Pub. Date: Aug. 8, 2013

(54) AEROBIC HEATING OF POURABLE SOLID MATTER

(71) Applicant: Röhren- und Pumpenwerk Bauer GmbH, Voitsberg (AT)

(72) Inventor: Dietrich EICHLER, Konigstein (DE)

(73) Assignee: Rohren- und Pumpenwerk Bauer GmbH, Voitsberg (AT)

(21) Appl. No.: 13/760,688

(22) Filed: Feb. 6, 2013

(30) Foreign Application Priority Data
Feb. 6, 2012 (DE) 20 2012 001 190.1

(51) Int. Cl. F27B 9/00

(52) U.S. Cl. CPC F27B 9/00
USPC 432/103

(57) ABSTRACT

The present disclosure refers to an arrangement for the aerobic heating of pourable solid matter, comprising: a rotatable rotary drum for receiving the pourable solid matter, at least one front wall which is non-rotatably arranged relative to the rotary drum for closing a front side of the rotary drum, and a sealing arrangement between the rotary drum and the front wall, the sealing arrangement comprising a cylindrical sealing surface coaxial to the rotary drum and a sealing element sliding on the cylindrical sealing surface.

### CROSS-REFERENCE TO RELATED APPLICATION

This application claims priority to German Patent Application No. 20 2012 001 190.1, filed Feb. 6, 2012, which is hereby incorporated by reference.

### BACKGROUND

The present disclosure refers to an arrangement for the aerobic heating of pourable solid matter.

The prior art is aware of rotary drums in which the hygienic status of separated pourable solids, e.g. from liquid cattle manure, is changed by aerobic heating in such a manner that the solid matter can be reused as bedding in stables. Publication WO 2006/053519 A1 shows a prior-art arrangement. To enhance the efficiency, a filling degree of more than 50% is desired in the rotary drum. To achieve this filling degree, a flap arrangement is described in WO 2006/053519 A1 for introducing the solid matter. The solid matter is discharged in the prior-art arrangement via a chute which is arranged at the level of the rotational axis of the drum. To maintain the filling degree of more than 50% in this case, the pourable solid matter must be retained at the outlet side by means of guide plates. This retention by means of guide plates does not work with all consistencies of the solid matter.

WO 2006/053519 A1, PCT/DE05/01995, and U.S. Patent Publication No. 2007/0294910 are all hereby incorporated by reference.

### SUMMARY

It is an object of some embodiments of the present disclosure to provide an arrangement for the aerobic heating of pourable solid matter that permits a filling degree of solid matter as high as possible, together with a low-cost production and a low-maintenance operation.

In some embodiments, the object is achieved by an arrangement for the aerobic heating of pourable solid matter, comprising: a rotatable rotary drum for receiving the solid matter, and at least one front wall which is non-rotatably arranged relative to the rotary drum for closing a front side of the rotary drum. Said non-rotatably arranged front wall can be used at only one front side or at both front sides of the rotary drum. According to the present disclosure, a sealing arrangement is provided between the rotary drum and the front wall. Said sealing arrangement comprises a cylindrical sealing surface coaxial to the rotary drum and a sealing element sliding on the cylindrical sealing surface. The cylindrical sealing surface is fixedly connected either to the rotary drum or to the front wall. The sealing element is then fasted to the respectively other component in a corresponding way. The non-rotatably arranged front wall according to the present disclosure makes it possible to arrange devices for introducing or discharging the solid matter at any desired place. Particularly, owing to the non-rotating front wall, it is possible to arrange a device for introducing and/or discharging the solid matter above the rotational axis of the rotary drum, whereby a filling degree of more than 50% is possible. The cylindrical sealing surface is an inner or outer surface of a cylindrical component. The sealing element slides on said cylindrical inner or outer surface.

In some embodiments, it may be provided that a width of the cylindrical sealing surface is greater than a support width of the sealing element on the cylindrical sealing surface. The width of the cylindrical sealing surface and the support width of the sealing element are here measured in the axial direction of the rotary drum. The support width of the sealing element on the cylindrical sealing surface is the portion of the sealing element that is in contact with the cylindrical sealing surface. The width of the cylindrical sealing surface is made larger than the support width. The rotary drum is here subject to expansion due to the temperature. The rotary drum is here particularly expanding in axial direction. The sealing arrangement shall also permit a reliable sealing of the gap between rotary drum and front wall upon expansion of the rotary drum. This is achieved through a correspondingly broad configuration of the cylindrical sealing surface. Particularly, the cylindrical sealing surface is made so broad that an expansion of the rotary drum by 20 mm, particularly by 25 mm, is possible.

Furthermore, lubrication in some embodiments may be provided for the sealing arrangement. To this end at least one lubricating nipple may be arranged to lubricate the sliding movement between the cylindrical sealing surface and the sealing element.

Furthermore, in some embodiments, it may be provided that a first diameter of the cylindrical sealing surface corresponds to at least 40%, particularly at least 50%, of a second diameter of the rotary drum. Particularly, the inner diameter of the rotary drum is measured. Owing to this relatively large diameter of the cylindrical sealing surface a correspondingly large front wall can also be used. As a consequence, the arrangements for introducing or discharging the solid matter can be arranged relatively far above the rotational axis of the drum, and the filling degree can thus be optimized

The sealing element in some embodiments may be configured as a lip seal. An integral, fully circumferential lip seal may be used. Alternatively, the sealing element may also be composed of individual segments. The lip seal may comprise a first portion firmly connected to the front wall or the rotary drum, and a second portion sliding on the cylindrical sealing surface. The first portion is substantially perpendicular to the second portion. “Substantially perpendicular” encompasses deviations of +10°.

In some embodiments, as an alternative to the lip seal, the sealing element may be designed as a packing gland.

In some embodiments, a configuration of an opening for introducing or discharging the solid matter is formed in the front wall. The solid matter is particularly introduced at a front side of the rotary drum and discharged at the opposite front side of the rotary drum. A chute may be arranged in the opening for discharging the solid matter. Said chute is particularly displaceable in a direction inclined relative to the axial direction of the rotary drum. The filling degree can be regulated inside the rotary drum by displacing the chute. The opening in the front wall through which the chute is inserted may be eccentrically positioned relative to the rotational axis of the rotary drum.

An auger in some embodiments may be arranged on the opening for introducing the solid matter. The opening for introducing the solid matter is also arranged particularly eccentrically relative to the rotational axis of the rotary drum.

In some embodiments, the arrangement comprises one of the non-rotatable front walls, as have just been described, on each of the two front sides of the rotary drum. Alternatively, the non-rotatable front wall may be arranged only at the introduction or discharge side of the rotary drum. In an embodiment, the flap system according to WO 2006/053519 A1 is used at the introduction side, and the non-rotatable front wall as is here described is used on the discharge side. The content of publication WO 2006/053519 A1 is explicitly incorporated herein by reference, particularly the configuration of the flap arrangement as shown therein.

Furthermore, in some embodiments, the arrangement comprises a frame in which the rotary drum is rotatably supported. A motor is provided for driving the rotary drum. The rotary drum may be arranged in a thermally insulated container.

### BRIEF DESCRIPTION OF THE DRAWINGS

Embodiments of the present disclosure are now explained in more detail with reference to the drawings, in which:

FIG. 1 is an isometric view of an arrangement of the present disclosure according to a first embodiment;

FIG. 2 is a first sectional view of the arrangement of the present disclosure according to the first embodiment;

FIG. 3 is a second sectional view of the arrangement of the present disclosure according to the first embodiment;

FIG. 4 shows a detail of the arrangement of the present disclosure according to the first embodiment;

FIG. 5 is a third sectional view of the arrangement of the present disclosure according to the first embodiment;

FIG. 6 is a fourth sectional view of the arrangement of the present disclosure according to the first embodiment; and

FIG. 7 shows a detail of the arrangement of the present disclosure according to a second embodiment.

### DETAILED DESCRIPTION

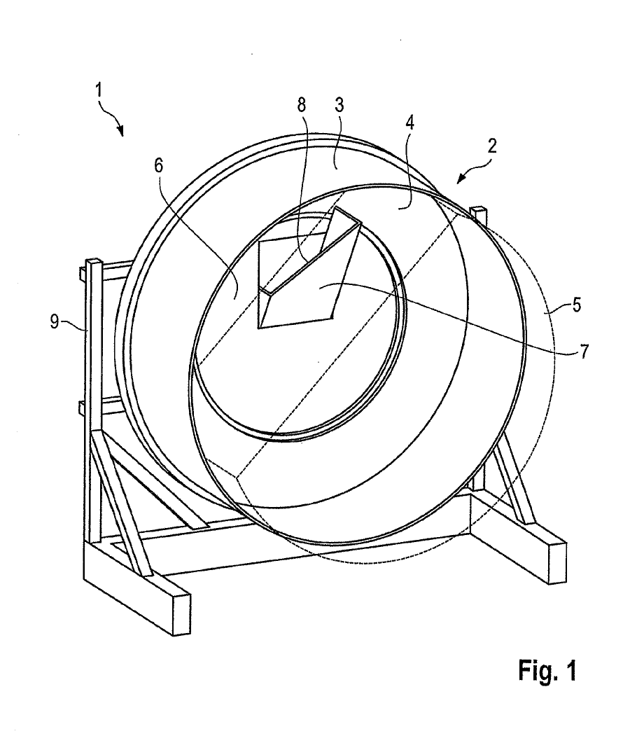

A first embodiment of the arrangement 1 for the aerobic heating of pourable solid matter is described with reference to FIGS. 1 to 6.

FIG. 1 shows a part of the arrangement 1 with a rotary drum 2 for receiving the pourable solid matter 5. The rotary drum 2 is rotatably supported in a frame 9. The front side of the rotary drum 2, as is shown herein, serves to discharge the solid matter 5.

The rotary drum 2 comprises a lateral surface 3 and a first ring wall 4. The first ring wall 4 is fixedly connected to the lateral surface 3. The first ring wall 4 closes part of the front side of the rotary drum 2. The substantial part of the front side of the rotary drum 2 is closed by a first front wall 6. Said first front wall 6 is non-rotatably arranged with respect to the rotary drum 2. To this end the first front wall 6 is fixedly connected to the frame 9. The first front wall 6 is penetrated by a chute 7. The solid matter 5 is discharged via said chute 7 out of the interior of the rotary drum 2. While the rotary drum 2 is rotating, the solid matter 5 is inclined in the rotary drum 2. An outlet edge 8 of the chute 7 is also inclined in a corresponding manner with respect to the horizontal, so that the solid matter 5 positioned at the top is mainly discharged.

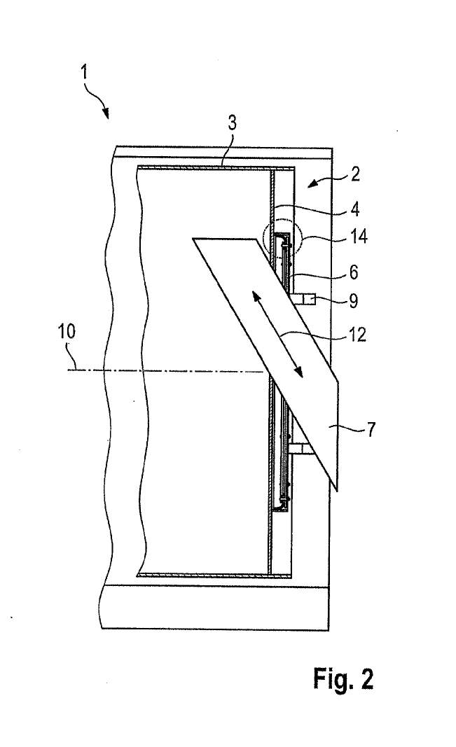

FIG. 2 shows a first sectional view of the arrangement 1. What can be seen herein is the rotational axis 10 of the rotary drum 2. The axial direction of the rotary drum 2 is also defined in parallel with said rotational axis 10. The chute 7 is displaceable along a plotted displacement direction 12. Said displacement direction 12 is inclined with respect to the rotational axis 10, especially at an angle between 10° and 80°. The filling degree in the rotary drum 2 can be regulated by retracting and extending the chute 7 along the displacement direction 12.

As shown herein, the first front wall 6 is fixedly connected to the frame 9. Said connection is particularly configured in such a manner that an adjustment of the first front wall 6 is possible in a direction perpendicular to the rotational axis 10. When the arrangement 1 is put into operation for the first time, the first front wall 6 must be aligned to be coaxial to the rotational axis 10.

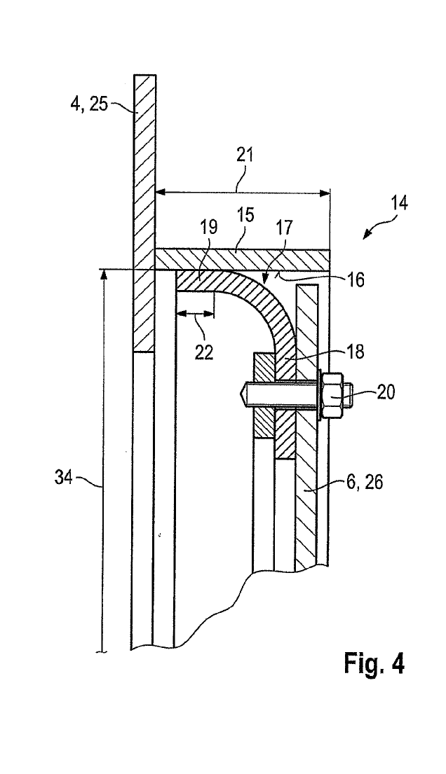

Furthermore, a sealing arrangement 14 is marked in FIG. 2. Said sealing arrangement 14 is shown in FIG. 4 in detail.

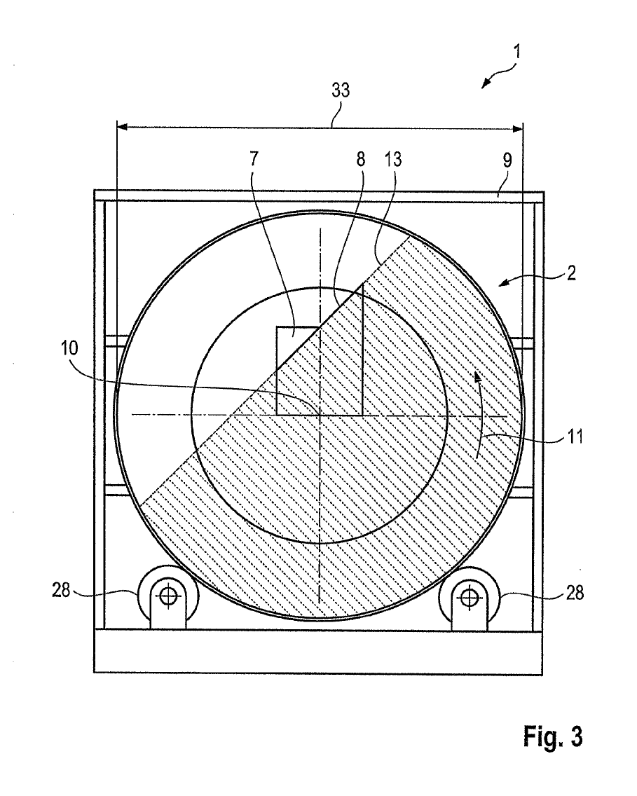

FIG. 3 shows a further sectional view of the arrangement 1. The filling level 13 of the solid matter 5 inside the rotary drum 2 is here plotted. The rotary drum 2 is filled up to 70% in the illustrated example. With the plotted rotational direction 11 of the rotary drum 2 the solid matter 5 is inclined with respect to the horizontal in the rotary drum 2. In conformity with this inclination of the filling level 13 the outlet edge 8 of the chute 7 is also inclined.

FIG. 3 further shows drive and/or guide rolls 28. On said rolls 28, the lateral surface 3 of the rotary drum 2 is guided with respect to the frame 9. Furthermore, said rolls 28 can also be driven to effect a rotation of the rotary drum 2.

Furthermore, FIG. 3 shows an inner diameter 33 of the rotary drum 2 (second diameter).

FIG. 4 shows the sealing arrangement 14 of the first embodiment. Shown is the first ring wall 4 of the rotary drum 2 with a cylindrical extension 15. The cylindrical extension 15 is arranged to be coaxial to the rotational axis 10. A cylindrical sealing surface 16 is formed on an inner surface of the cylindrical extension 15. Consequently, the cylindrical sealing surface 16 is also over the whole circumference and coaxial to the rotational axis 10. A sealing element 17 is fastened to the first front wall 6. Said sealing element 17 extends over the whole circumference about the rotational axis 10 and is made integral. A first portion 18 and a second portion 19 are defined on the sealing element 17. The first portion 18 is firmly connected, particularly screwed, to the first front side 6. The second portion 19 is bent by about 90° relative to the first portion 18. The second portion 19 of the sealing element 17 slides on the cylindrical sealing surface 17. Not shown are lubricating nipples of the sealing arrangement 16 that ensure a grease supply for the sliding contact between the sealing surface 16 and the sealing element 17.

The cylindrical sealing surface 16 has a width 21. The width 21 is measured in parallel with the rotational axis 10. The contact surface between the sealing element 17 and the cylindrical sealing surface 16 has a support width 22. The support width 22 is also measured in parallel with the rotational axis 10. The width 21 is much larger than the support width 22. This permits a displacement of the rotary drum 2, e.g. by thermal expansion, along the rotational axis 10, simultaneously ensuring a sealing of the gap between rotary drum 2 and first front wall 6.

Furthermore, a diameter 34 (first diameter) of the cylindrical sealing surface 16 is plotted in FIG. 4. Said diameter 34 is at least 40% of the inner diameter 33 (see FIG. 3).

Furthermore, FIG. 4 shows a screw connection 20 for connecting the sealing element 17 to the first front wall 6.

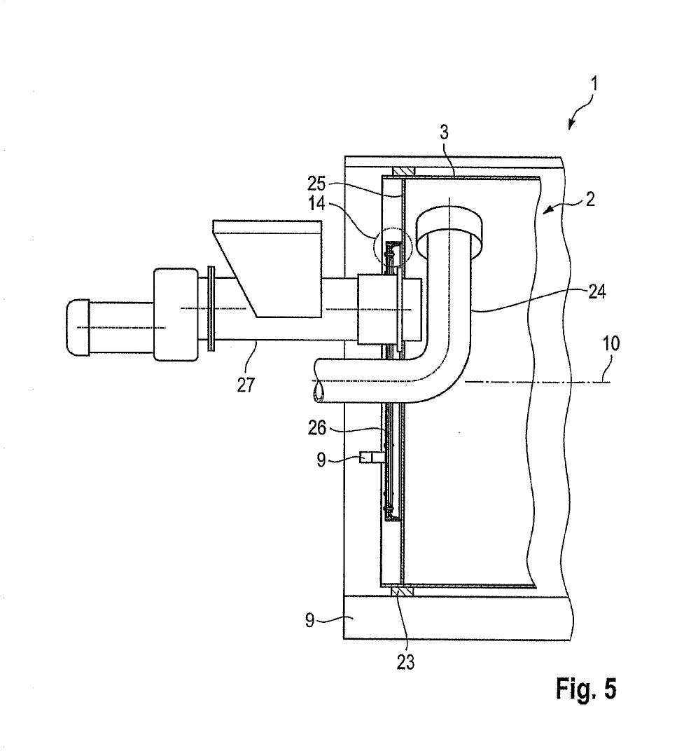

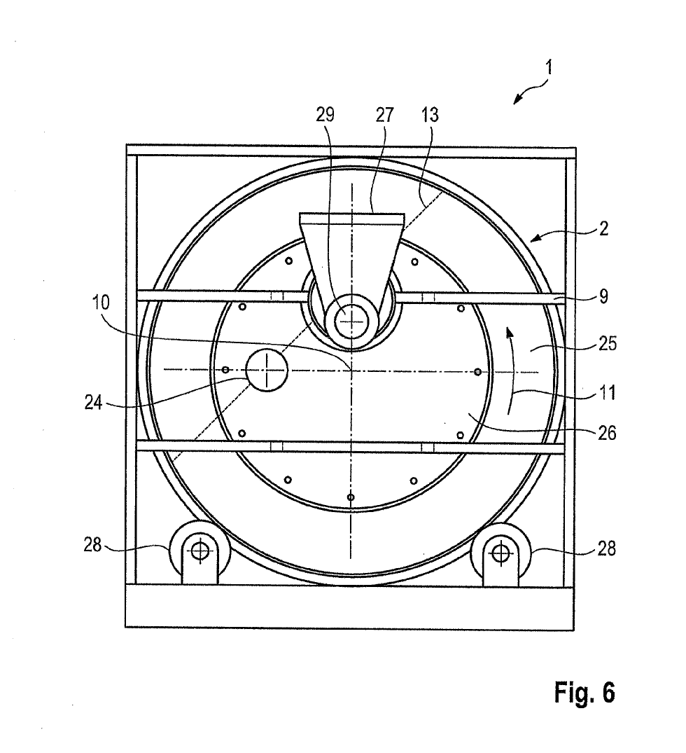

FIGS. 5 and 6 show in section the introduction side of the rotary drum 2. At this side the rotary drum 2 comprises a second ring wall 25 which partly closes the rotary drum 2 at the front side. The remaining part of the rotary drum 2 at the front side is closed via a second front wall 26. Said second front wall 26 is also non-rotatably connected to the frame 9. The sealing arrangement 14, as shown in FIG. 4, is formed between the second front wall 26 and the second ring wall 25. The sealing arrangement 14 between the second ring wall 25 and the second front wall 26 is of the same construction and has the same dimensions as the sealing arrangement 14 between the first ring wall 4 and the first front wall 6.

Furthermore, FIG. 5 shows a rail guide 23 between the outer surface of the rotary drum 2 and the frame 9. Particularly, a rail is here welded to the lateral surface 3 over the whole circumference. Said rail is guided with respect to the frame 9, particularly also in axial direction.

The second front wall 26 is penetrated eccentrically relative to the rotational axis 10 by an introduction system 27. Said introduction system 27 comprises an auger 29 (see FIG. 6), a drive for the auger 29, and a hopper.

Furthermore, FIG. 5 shows a vent pipe system 24 with which air can be discharged out of the rotary drum 2 to the outside.

FIG. 6 shows that the auger 29 is arranged in horizontal direction above the rotational axis 10. The rotary drum 2 can thereby be loaded with a filling degree of more than 50%.

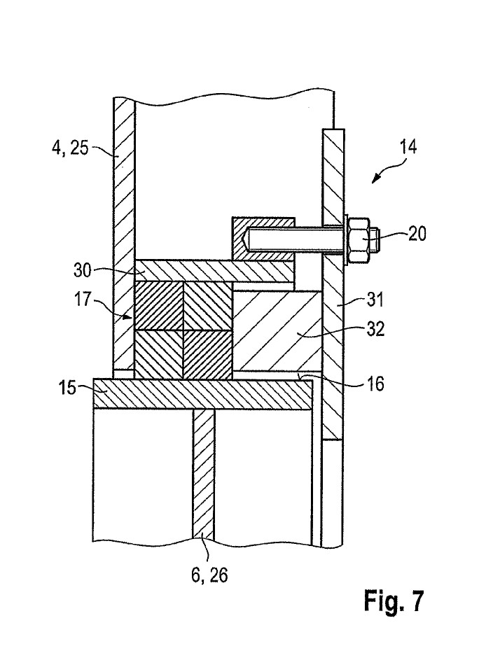

FIG. 7 shows a sealing arrangement 14 of an arrangement 1 according to a second embodiment. The sealing arrangement 14 in the second embodiment can be used on one or both front walls 6, 26. FIG. 7 shows the sealing element 17, configured as a packing gland. Four individual packing glands are here connected to the first ring wall 4 and to the second ring wall 25, respectively. A further cylindrical extension 30 is arranged on the first ring wall 4 and the second ring wall 25, respectively. Said further extension 30 is arranged to be coaxial to the rotational axis 10. The packing glands are inserted radially on the inside of the further extension 30. The packing glands are packed in axial direction by means of a packing ring 32 and a locking ring 31. The locking ring 31 is connected via the screw connection 20 to the further extension 30. The locking ring 31 and thus the packing ring 32 are clamped in axial direction via the screw connection 20.

In the second embodiment the cylindrical extension 15 is part of the front wall 6, 26. The cylindrical sealing surface 16 is an outer surface of the cylindrical extension 15 in a corresponding manner.

In both variants of the sealing arrangement 14 the sealing element 17 can be arranged on the respectively other component. Hence, it is provided in FIG. 4 that the sealing element 17 which is configured as a lip seal is connected to the rotary drum 2. The cylindrical sealing surface 16 would then be formed on the front wall 6 in a corresponding manner. FIG. 7 provides the alternative that the sealing element 17, which is designed as a packing gland, is firmly connected to the front wall 6, 26. The cylindrical sealing surface 16 would then be fixedly formed on the rotary drum 2 in a corresponding manner.

Furthermore, it is provided that just the discharge side of the rotary drum 2 is configured with the sealing arrangement 14, as has been presented here. The solid matter is here introduced via the flap arrangement disclosed in WO 2006/053519 A1. The configuration of the flap arrangement in WO 2006/053519 A1 is part of the present disclosure.

In some embodiments, there may be an arrangement (1) for the aerobic heating of pourable solid matter (5), comprising: a rotatable rotary drum (2) for receiving the pourable solid matter (5), at least one front wall (6, 26) which is non-rotatably arranged relative to the rotary drum (2) for closing a front side of the rotary drum (2), and a sealing arrangement (14) between the rotary drum (2) and the front wall (6, 26), the sealing arrangement (14) comprising a cylindrical sealing surface (16) coaxial to the rotary drum (2) and a sealing element (17) sliding on the cylindrical sealing surface (16).

The present disclosure may include one or more of the following concepts:

A. An arrangement (1) for the aerobic heating of pourable solid matter (5), comprising:
a rotatable rotary drum (2) for receiving the pourable solid matter (5),
at least one front wall (6, 26) which is non-rotatably arranged relative to the rotary drum (2) for closing a front side of the rotary drum (2), and
a sealing arrangement (14) between the rotary drum (2) and the front wall (6, 26), the sealing arrangement (14) comprising a cylindrical sealing surface (16) coaxial to the rotary drum (2) and a sealing element (17) sliding on the cylindrical sealing surface (16).

B. The arrangement according to paragraph A., characterized in that a width (21) of the cylindrical sealing surface (16), measured in axial direction (10) of the rotary drum (2), is greater than a support width (22) of the sealing element (17) on the cylindrical sealing surface (16), measured in axial direction (10) of the rotary drum (2), so that an expansion of the rotary drum (2) in axial direction (10), particularly by 20 mm, particularly by 25 mm, is possible.

C. The arrangement according to any one of the preceding paragraphs, characterized in that a first diameter (24) of the cylindrical sealing surface (16) corresponds to at least 40%, particularly at least 50%, of a second diameter (33) of the rotary drum (2).

D. The arrangement according to any one of the preceding paragraphs, characterized in that the sealing element (17) comprises a lip seal.

E. The arrangement according to paragraph D, characterized in that the lip seal comprises a first portion (18) firmly connected to the front wall (6, 26) or the rotary drum (2), and a second portion (19) sliding on the cylindrical sealing surface (16), the first portion (18) being substantially vertically positioned relative to the second portion (19).

F. The arrangement according to paragraphs A to C, characterized in that the sealing element (17) comprises a packing gland.

G. The arrangement according to any one of the preceding paragraphs, characterized in that an opening for introducing or discharging the solid matter (5) is formed in the front wall (6, 26).

H. The arrangement according to paragraph G, characterized by a chute (7) arranged in the opening for discharging the solid matter (5), the chute (7) being displaceable in a direction (12) inclined relative to the axial direction (10) of the rotary drum (2).

I. The arrangement according to any one of paragraphs G or H, characterized by an auger (29) at the opening for introducing the solid matter (5), the opening being arranged particularly eccentrically relative to the rotational axis (10) of the rotary drum (2).

J. The arrangement according to any one of the preceding paragraphs, having a respective one of the non-rotatable front walls (6, 26) on the two front sides of the rotary drum (2).

In some embodiments, the references numerals in the figures may be identified as follows:

| | |
|---|---|
| 1 | Arrangement |
| 2 | Rotary drum |
| 3 | Lateral surface |
| 4 | First ring wall |
| 5 | Pourable solid matter |
| 6 | First front wall |
| 7 | Chute |
| 8 | Outlet edge |
| 9 | Frame |
| 10 | Rotational axis |
| 11 | Rotational direction |
| 12 | Displacement direction |
| 13 | Filling level |
| 14 | Sealing arrangement |
| 15 | Cylindrical extension |
| 16 | Cylindrical sealing surface |
| 17 | Sealing element |
| 18 | First portion |
| 19 | Second portion |
| 20 | Screw connection |
| 21 | Width |
| 22 | Support width |
| 23 | Rail guide |
| 24 | Venting |
| 25 | Second ring wall |
| 26 | Second front wall |
| 27 | Introduction system |
| 28 | Drive/guide |
| 29 | Auger |
| 30 | Further extension |
| 31 | Locking ring |
| 32 | Packing ring |
| 33 | Second diameter |
| 34 | First diameter |

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

What is claimed is:

1. An arrangement for the aerobic heating of pourable solid matter, comprising:
a rotatable rotary drum configured to receive the pourable solid matter,
at least one front wall which is non-rotatably arranged relative to the rotary drum that is configured to close a front side of the rotary drum, and
a sealing arrangement between the rotary drum and the front wall, the sealing arrangement comprising a cylindrical sealing surface coaxial to the rotary drum and a sealing element slidable on the cylindrical sealing surface.

2. The arrangement of claim 1, wherein a width of the cylindrical sealing surface, measured in an axial direction of the rotary drum, is greater than a support width of the sealing element on the cylindrical sealing surface, measured in the axial direction of the rotary drum, so that an expansion of the rotary drum in the axial direction is possible.

3. The arrangement of claim 2, wherein the expansion of the rotary drum in the axial direction is possible by 20 mm.

4. The arrangement of claim 2, wherein the expansion of the rotary drum in the axial direction is possible by 25 mm.

5. The arrangement of claim 1, wherein a first diameter of the cylindrical sealing surface corresponds to at least 40% of a second diameter of the rotary drum.

6. The arrangement of claim 1, wherein a first diameter of the cylindrical sealing surface corresponds to at least 50% of a second diameter of the rotary drum.

7. The arrangement of claim 1, wherein the sealing element comprises a lip seal.

8. The arrangement of claim 7, wherein the lip seal comprises a first portion firmly connected to one of the front wall or the rotary drum, and a second portion configured for sliding on the cylindrical sealing surface, the first portion being substantially vertically positioned relative to the second portion.

9. The arrangement of claim 1, wherein the sealing element comprises a packing gland.

10. The arrangement of claim 1, further comprising an opening formed in the front wall that is configured to introduce or discharge the solid matter.

11. The arrangement of claim 10, wherein a chute is arranged in the opening for discharging the solid matter, the chute being displaceable in a direction inclined relative to the axial direction of the rotary drum.

12. The arrangement of claim 10, further comprising an auger at the opening for introducing the solid matter, the opening being arranged eccentrically relative to a rotational axis of the rotary drum.

13. The arrangement of claim 11, further comprising an auger at the opening for introducing the solid matter, the opening being arranged particularly eccentrically relative to a rotational axis of the rotary drum.

14. The arrangement of claim 1, further comprising having a respective one of the non-rotatable front walls on two front sides of the rotary drum.

15. An arrangement for the aerobic heating of pourable solid matter, comprising:
a rotatable rotary drum configured to receive the pourable solid matter,
at least one front wall which is non-rotatably arranged relative to the rotary drum that is configured to close a front side of the rotary drum,
a sealing arrangement between the rotary drum and the front wall, the sealing arrangement comprising a cylindrical sealing surface coaxial to the rotary drum and a sealing element slidable on the cylindrical sealing surface, wherein a width of the cylindrical sealing surface, measured in an axial direction of the rotary drum, is greater than a support width of the sealing element on the cylindrical sealing surface, measured in the axial direction of the rotary drum, so that an expansion of the rotary drum in the axial direction is possible,
an opening formed in the front wall that is configured to introduce or discharge the solid matter,
a chute arranged in the opening for discharging the solid matter, the chute being displaceable in a direction inclined relative to the axial direction of the rotary drum, and
an auger at the opening for introducing the solid matter, the opening being arranged eccentrically relative to a rotational axis of the rotary drum,
wherein a respective one of the non-rotatable front walls is on two front sides of the rotary drum.

16. The arrangement of claim 15, wherein the sealing element comprises a lip seal.

17. The arrangement of claim 16, wherein the lip seal comprises a first portion firmly connected to one of the front wall or the rotary drum, and a second portion configured for sliding on the cylindrical sealing surface, the first portion being substantially vertically positioned relative to the second portion.

18. The arrangement of claim 15, wherein the sealing element comprises a packing gland.
